(19) United States
(12) Patent Application Publication
(10) Pub. No.: US 2018/0281815 A1
(43) Pub. Date: Oct. 4, 2018

(54) PREDICTIVE TELEASSISTANCE SYSTEM FOR AUTONOMOUS VEHICLES

(71) Applicant: Uber Technologies, Inc., San Francisco, CA (US)

(72) Inventor: Anthony Stentz, Pittsburgh, PA (US)

(21) Appl. No.: 15/959,100

(22) Filed: Apr. 20, 2018

Related U.S. Application Data
(60) Provisional application No. 62/479,465, filed on Mar. 31, 2017.

(51) Int. Cl. B60W 50/00; B60W 50/14; G01C 21/34; G08G 1/01; H04W 4/40

(52) U.S. Cl. CPC B60W 50/0097; B60W 50/14; B60W 2050/046; G08G 1/0129; H04W 4/40; G01C 21/3438

(57) ABSTRACT

A predictive teleassistance system cab monitor autonomous vehicles (AVs) operating throughout a given region, and predict teleassistance locations within the given region. Using route data for a respective AV, the system can determine a convergence of the respective AV with the predicted teleassistance location, and generate a plurality of decision options for a human teleassistance operator to resolve the predicted teleassistance location for the respective AV. The system may receive a selection of a decision option from the human teleassistance operator, and transmit a teleassistance command corresponding to the selected decision option to the respective AV in order to cause the respective AV to preemptively resolve the predicted teleassistance location.

### CROSS-REFERENCE TO RELATED APPLICATION

This application claims the benefit of priority to U.S. Provisional Patent Application No. 62/479,465, entitled “Predictive Teleassistance for Autonomous Vehicles,” filed on Mar. 31, 2017.

### BACKGROUND

Autonomous vehicles (AVs) can navigate through typical driving environments without human input utilizing a sensor suite that can be comprised of LIDAR devices, stereoscopic and monocular cameras, radar, and other sensor instruments. The control system of an AV can analyze a sensor view of the AV's surroundings, generated by the AV's sensor suite, to identify and classify objects of interest and modulate braking, steering, acceleration, and other control inputs in response.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example predictive teleassistance system in communication with AVs and remote teleassistance operators, according to examples described herein;

FIG. 2 is a block diagram illustrating an autonomous vehicle in communication with a predictive teleassistance system, as described herein;

FIG. 3 shows an example of an autonomously controlled autonomous vehicle utilizing sensor data to navigate an environment in accordance with example implementations;

FIGS. 4A through 4D illustrate example implementations of an autonomous vehicle utilizing predictive teleassistance, in accordance with example implementations;

FIGS. 5A and 5B are flow charts describing example methods of predicting and preemptively resolving teleassistance locations for AVs, according to examples described herein;

FIG. 6 is a flow chart describing an example method of receiving predictive teleassistance by an autonomous vehicle, according to examples described herein;

FIG. 7 is a block diagram illustrating a computer system for an autonomous vehicle upon which examples described herein may be implemented; and

FIG. 8 is a block diagram illustrating a computer system for a backend datacenter upon which example predictive teleassistance systems described herein may be implemented.

### DETAILED DESCRIPTION

An autonomous vehicle (AV) can include a sensor suite to generate a live sensor view of a surrounding area of the AV and acceleration, braking, and steering systems autonomously operated by a control system. In various implementations, the control system can dynamically analyze the sensor view of the surrounding area and a road network map (e.g., a highly detailed localization map) in order to autonomously operate the acceleration, braking, and steering systems along a current route to a destination.

In certain examples, the AV can include a communication interface to enable the control system to communicate to a backend teleassistance system. In one aspect, the backend teleassistance system can be implemented through one or more datacenters and can provide assistance to AVs operating throughout a given region (e.g., a metroplex such as the San Francisco Bay metropolitan area). In facilitating fluidity in transport and traffic flow, a predictive teleassistance system for AVs is described herein. The predictive teleassistance system can monitor the AVs operating throughout the given region, and predict or otherwise identify teleassistance locations within the given region.

As provided herein, a “teleassistance location” can comprise an anticipated location or scenario where AVs are likely to request or benefit from the assistance of remote, human operators. Such a location can correspond to an area or location that AVs have historically requested assistance based on historical data compiled from previous teleassistance requests. For example, an AV's computational resources may become overwhelmed or confused in certain areas of heavy traffic (e.g., pedestrian and bicycle traffic, mass egress events, etc.), where there exists an indeterminate object which the AV is unable to classify (e.g., a pothole), when an occlusion is detected in the sensor view of the AV, when approaching uncommon driving scenarios (e.g., road construction areas, poorly maintained roads, debris areas, etc.)—each of which may normally cause the AV to request remote assistance one or multiple times.

In various implementations, the predictive teleassistance system can predict the teleassistance location using historical data, live mapping data, access to third party data (e.g., event data, such as schedule and timing information for conferences, sporting events, concerts, festivals, and other mass egress events), and the like. In some aspects, utilizing event data can comprise estimating traffic impact caused by a mass egress event corresponding to an event, and preemptively addressing the estimated traffic impact through predictive teleassistance decisions made by human operators, and corresponding teleassistance commands executable by AVs to preemptively avoid or address the estimated traffic. Using route data for AVs operating throughout the region, the predictive teleassistance system can determine convergences in the routes of the AVs with the predicted teleassistance location. For example, the AVs may each have a current destination inputted by either an on-demand transportation service or a passenger within the AV. In some aspects, the most optical route to the destination may be determined by the AV alone, a backend mapping service, the on-demand transportation service, the predictive teleassistance system, or a combination of the foregoing.

According to examples described herein, the route for the AV to the destination may be analyzed by the predictive teleassistance system in light of the predicted teleassistance location. For example, a trajectory of the AV may be identified along the route, and the predictive teleassistance system can determine a set of decision options for the AV to preemptively resolve the teleassistance location for the AV prior to arriving at the predicted teleassistance location. For example, each determined decision option can comprise an alternative route to bypass the teleassistance location, or one or more actions to be executed by the control system of the AV to address the teleassistance location.

Examples described herein recognize that, with current technology in the field of autonomous vehicle technology, combining automated analysis with human decision-making offers significant advantages over purely autonomous systems. According to various implementations, the predictive teleassistance system can generate a user interface feature comprising the set of decision options in order to enable a human teleassistance operator to preemptively resolve the teleassistance location for the respective AV. The human teleassistance operator may then select a decision option from the set, and the predictive teleassistance system may then receive data indicating the selection. Based on the selection, the predictive teleassistance system can transmit a teleassistance command corresponding to the selected decision option to cause the respective AV to preemptively resolve the predicted teleassistance location.

As provided herein, preemptive resolution of the predicted teleassistance location can occur in a manner other than real time. That is, the backend teleassistance system can identify such teleassistance locations prior to the AV, and thus initiate the teleassistance communication as opposed to the AV. In certain implementations, the AV may initiate the predictive teleassistance process. For example, in certain scenarios, the AV may identify a potential teleassistance location in the live sensor view along a current route prior to approaching the location. In such a scenario, the AV can generate and transmit a preemptive teleassistance inquiry to the predictive teleassistance system, which can include sensor data (e.g., image data) indicating the potential teleassistance location.

According to one or more examples, for multiple AVs converging on a single teleassistance location on the same or similar trajectory, a single human selection of a decision option can enable the predictive teleassistance system to act a master override (e.g., a route override) for each of the multiple AVs. In variations, the human operator may be asked to provide multiple decision option selections for a single teleassistance location (e.g., in a ranked order) to enable the predictive teleassistance system to transmit multiple teleassistance commands to the multiple AVs. Based on the multiple selected decision options, the predictive teleassistance system may then transmit distinct teleassistance commands to the AVs to more optimally address the teleassistance location.

Among other benefits, the examples described herein achieve a technical effect of predicting problematic locations in which AVs may typically initiate a request for teleassistance from a human operator. In various examples described, the predictive teleassistance system can leverage live traffic data, historical teleassistance data, and/or third party event data in order to predict teleassistance locations prior to them being identified by AVs, and preemptively address them before necessitating reactive inquiries and responses. The technical effect of such a solution can prevent AV-initiated teleassistance requests by individual AVs—which can result in traffic slow-downs or pauses by the AV. Furthermore, on a system wide scale, the technical effect can contribute to increased traffic safety and fluidity due to teleassistance request preemption.

As used herein, a computing device refers to devices corresponding to desktop computers, cellular devices or smartphones, personal digital assistants (PDAs), laptop computers, tablet devices, virtual reality (VR) and/or augmented reality (AR) devices, wearable computing devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, virtual reality (VR) or augmented reality (AR) computers, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as those carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

As provided herein, the terms “autonomous vehicle” (AV) may be used interchangeably to describe any vehicle operating in a state of autonomous control with respect to acceleration, steering, and braking. Different levels of autonomy may exist with respect to AVs. For example, some vehicles may enable autonomous control in limited scenarios, such as on highways. More advanced AVs can operate in a variety of traffic environments without any human assistance. Accordingly, an “AV control system” can process sensor data from the AV's sensor array, and modulate acceleration, steering, and braking inputs to safely drive the AV along a given route.

System Description

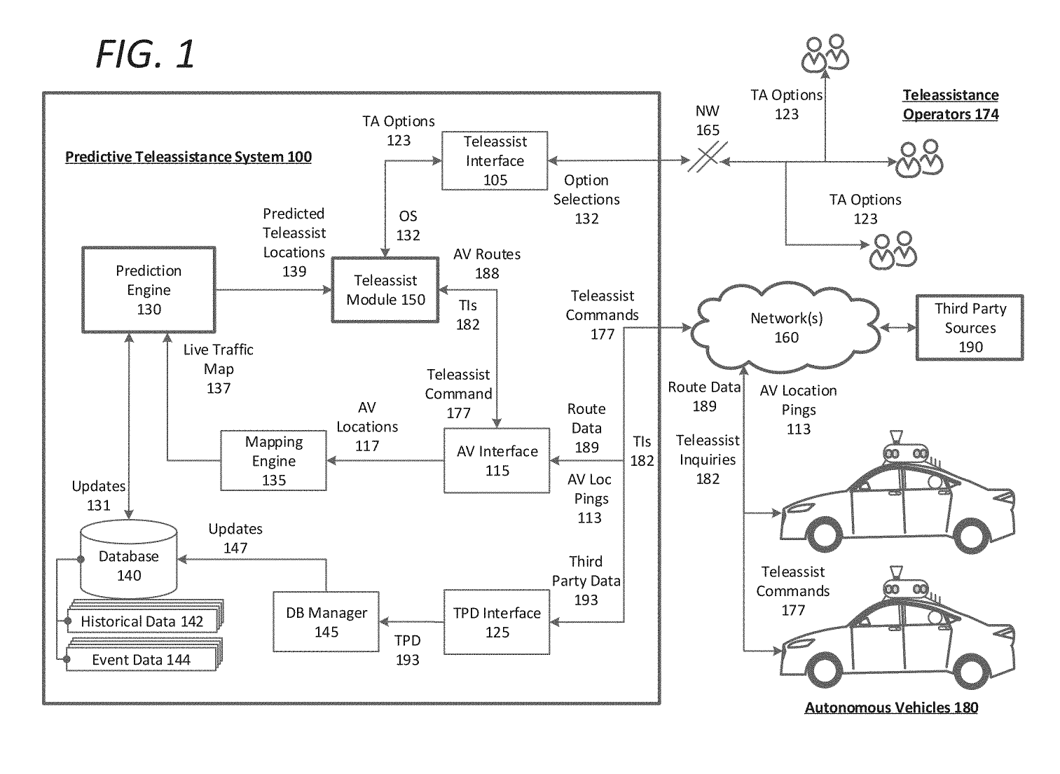

FIG. 1 is a block diagram illustrating an example predictive teleassistance system in communication with AVs and remote teleassistance operators, according to examples described herein. The predictive teleassistance system 100 can include an autonomous vehicle (AV) interface 115 to communicate, over one or more networks 160, with AVs 180 operating throughout a given region, such as a metropolitan area. The AV interface 115 can receive AV location pings 113 transmitted by the AVs 180 (e.g., GPS pings), which indicate the AVs' 180 current locations. The AV interface 115 can further receive route data 188 indicating the current route of an AV 180 to a destination. In certain aspects, the route data 188 can be received from the AVs 180 themselves, from a remote resource (e.g., an on-demand transportation system), or can determine the routes for the AVs 180 independently.

The predictive teleassistance system 100 can include a mapping engine 135 to generate live map and traffic data. In certain implementations, the mapping engine 135 can determine the dynamic AV locations 117 of the AVs 180 as they operate and drive throughout the given region (e.g., based on the AV location pings 113 from the AVs 180). In some aspects, the mapping engine 135 can generate a live traffic map 137 based on the AV locations 117 and the generated map and traffic data. For example, the mapping engine 135 can utilize sequential AV location pings 113 to determine the velocity and direction of the AVs 180 within the mapped region to generate the live traffic map 137. In variations, the predictive teleassistance system 100 can access a third party mapping service to analyze a live traffic map 137.

Examples described herein recognize that the AVs 180 may, on occasion, require remote assistance in resolving certain situations, such as indeterminate objects (e.g., a plastic bag or a misshapen pothole), moving through extremely high caution areas (e.g., high density pedestrian areas), occlusions in the sensor view, traffic incidents or traffic jams, fault conditions on the AV 180 (e.g., a malfunctioning or misaligned sensor, a flat tire, a diagnostics problem, etc.), and the like. In such situations, an AV 180 may initiate communications by identifying the teleassist situation in its live sensor view of its surroundings, and generate a teleassistance inquiry 182 for transmission to the teleassistance system 100 over one or more networks 160. In some examples, the teleassistance inquiry 182 can include sensor data (e.g., image data) indicating the teleassistance scenario. A teleassist module 150 can identify the location, trajectory, and route of the AV 180 and generate a set of teleassistance options 123 indicating a plurality of decisions that the AV 180 can make in order to resolve the teleassistance location.

As described herein, the teleassistance system 100 can be connected with a number of human teleassistance operators 174 over a local or wide area network 165 via a teleassist interface 105. The teleassistance system 100 can provide the set of teleassistance options 123 to a human teleassistance operator 174 in order to enable the operator 174 to make a selection. For example, the teleassistance system 100 can transmit data causing a user interface to be generated on a computer screen of the teleassistance operator 174. The user interface can include the set of teleassistance options 123 and can provide additional data indicating the location 139, such as image data, traffic data, and/or map data. The human teleassistance operator 174 may then make an option selection 132 of one of the teleassistance options 123, and data indicating the option selection 132 may be transmitted back to the teleassist interface 105, and to the teleassist module 150.

Based on the option selection 132 by the human teleassistance operator 174, the teleassist module 150 can generate a teleassist command 177 instructing the AV 180 to execute the selected teleassistance option 132. The AV interface 115 can transmit the teleassist command 177 to the AV 180 in order to enable the AV 180 to resolve the teleassistance location. As provided herein, the teleassist command 177 can correlate to the selected decision option 132 by the operator 174. Thus, ultimately, the teleassistance system 100 performs an initial analysis of the teleassistance scenario based on the teleassistance inquiry 182, map data, live traffic data, image data from the AV 180, and/or event data 144 local to the teleassistance location identified by the AV 180. Given the trajectory of the AV 180 along a current route, the teleassist module 150 can generate a plurality of teleassistance options 123 comprising a set of potential decisions for the AV 180 to address the teleassistance location or situation.

The predictive teleassistance system 100 may then leverage human cognition in making the final decision for the AV 180. In various aspects, the teleassistance operator 174 may be presented with the set of teleassistance options 123 on a user interface (e.g., on a personal computer screen or mobile computing device), and may perform a single input (e.g., a click or touch input) to make the option selection 132. Thereafter, the teleassist module 150 can provide a teleassist command 177 corresponding to the option selection 132 to the AV 180, which can execute the human decision accordingly. The foregoing process allows for AV 180-initiated teleassistance utilizing teleassistance inquiries 182 when the AV 180 detects or otherwise determines a problem (e.g., sensor fault, occlusion, a detected indeterminate object, overloaded data processing, etc.). As described herein, the teleassistance system 100 can also comprise predictive properties that can preempt the AVs 180 in transmitting teleassistance inquiries 182.

In various implementations, the predictive teleassistance system 100 can include a prediction engine 130 that can analyze aspects such as a live traffic map 137, historical data 142, event data 144, and the like. As provided herein, the historical data 142 can comprise previous teleassistance data indicating teleassistance inquiries 182 and correlated teleassist commands 177 provided to resolve teleassist scenarios initiated by the AVs 180. In some aspects, the prediction engine 130 can also parse through the historical data 142 to determine effectiveness rankings for the teleassist commands 177 in resolving recurring teleassist scenarios. In doing so, the prediction engine 130 can provide updates 131 to a database 140 storing the historical data 142 organizing and editing the historical data 142 to, for example, delete ineffective teleassist option selections 132 for a given teleassist scenario or rank teleassistance commands 177 based on effectiveness for a recurring teleassistance scenario.

As further provided herein, the predictive teleassistance system 100 can include a third party data interface 125 to connect with third party sources 190 to access third party data 193, such as event data 144 that may contribute to causing a teleassistance scenario or location. The event data 144 can comprise schedules corresponding to mass egress events caused by, for example, a sporting venue, concert venue, office building(s), conference center, airport, train or bus station, and the like. In some aspects, the third party interface 125 can dynamically access the third party source 190 to monitor the progression of an event, in order to enable the prediction engine 130 to estimate the precise timing and impact of a resultant mass egress event. Such dynamic access and monitoring may be performed by a database manager 145 of the predictive teleassistance system 100, which can manage the event data 144 as dynamic data for analysis or monitoring by the prediction engine 130. Such dynamic event data 144 can correspond to live timing characteristics of an event, such as a clock or progression data for a sporting event, a live updated schedule of a concert, real-time train, bus, or flight arrival data, and the like.

According to various examples, the prediction engine 130 can also monitor and analyze the live traffic map 137 for certain patterns or traffic characteristics that indicate an upcoming teleassistance scenario. For example, the prediction engine 130 can identify a traffic scenario on the live traffic map 137 and, utilizing historical traffic and teleassistance data 142 in the database 140, the prediction engine 130 can pinpoint or otherwise predict hotspots on the live traffic map 137 where a high probability exists for a predicted teleassistance location 139. Such hotspots can correspond to areas where teleassistance inquiries 182 have historically been received from AVs 180 based—directly or indirectly—on the location of the identified traffic scenario. Thus, an incident or mass egress event at point A on the live traffic map 137 can indirectly cause a teleassistance location 139 at point B, which can be predicted by the prediction engine 130.

In certain examples, the prediction 130 can analyze the event data 144, historical data 142, and the live traffic map 137 to calculate probabilities for any number of locations on the map 137 that a teleassistance location 139 result. That is, given a certain location (e.g., a complex intersection involving several vehicle ingress and egress points, pedestrian pathways, bike lanes, and other potential hazards), the prediction engine 130 can periodically or dynamically calculate a probability that an AV 180 approaching the location will request teleassistance. The probability calculation can be affected directly by general traffic at the location (e.g., bike lane traffic, pedestrian traffic, and vehicle traffic), or indirectly by such aspects as distant traffic situations, mass egress events, road construction or closure areas, and the like. In various implementations, once the probabilistic calculation for a given location exceeds a certain threshold (e.g., a 90% probability of a near-future teleassistance inquiry 182), the prediction engine 130 can transmit data indicating the predicted teleassist location 139 to the teleassist module 150.

The teleassist module 150 can utilize the AV routes 188 to identify AVs 180 converging towards the predicted teleassist location 139. For example, the teleassist module 150 can identify AVs 180 that are within a predetermined distance from, and that are converging towards, the predicted teleassist location 139. In some aspects, the teleassist module 150 can group AVs 180 together that have common trajectories towards the predicted teleassist location 139. For each AV 180 or group of AVs 180, the teleassist module 150 can generate a set of teleassist decision options 123. As described, each teleassist decision option 123 can comprise an action performable by the AV 180 that can preemptively enable the AV 180 to address or resolve the predicted AV location 139 prior to the AV 180 approaching or intersecting with the predicted AV location 139. Such decision options 132 can correspond to alternate routes, lane selections, wait commands, data classifying an indeterminate object, and the like.

The teleassist module 150 may then transmit the set of teleassist options 123 to a human teleassistance operator 174 via the teleassist interface 105 and network 165. The teleassistance operator 174 can then make an option selection 132 of one of the teleassist options 123, which can be transmitted back to the teleassist module 150. In some aspects, the teleassistance operator 174 can make sequential selections of two or more teleassist options 123 to provide a ranked set of option selection 132 for the teleassist module 150 (e.g., in handling a group of AVs 180 along a common trajectory towards the predicted teleassist location 139). The teleassist module 150 may then generate a teleassist command 177 corresponding to the selected decision option 132, and transmit the teleassist command 177 to the relevant AV(s) 180. Thereafter, the AV(s) 180 can preemptively address or resolve the predicted teleassistance location 139 prior to arrival by executing the teleassist command 177.

Autonomous Vehicle

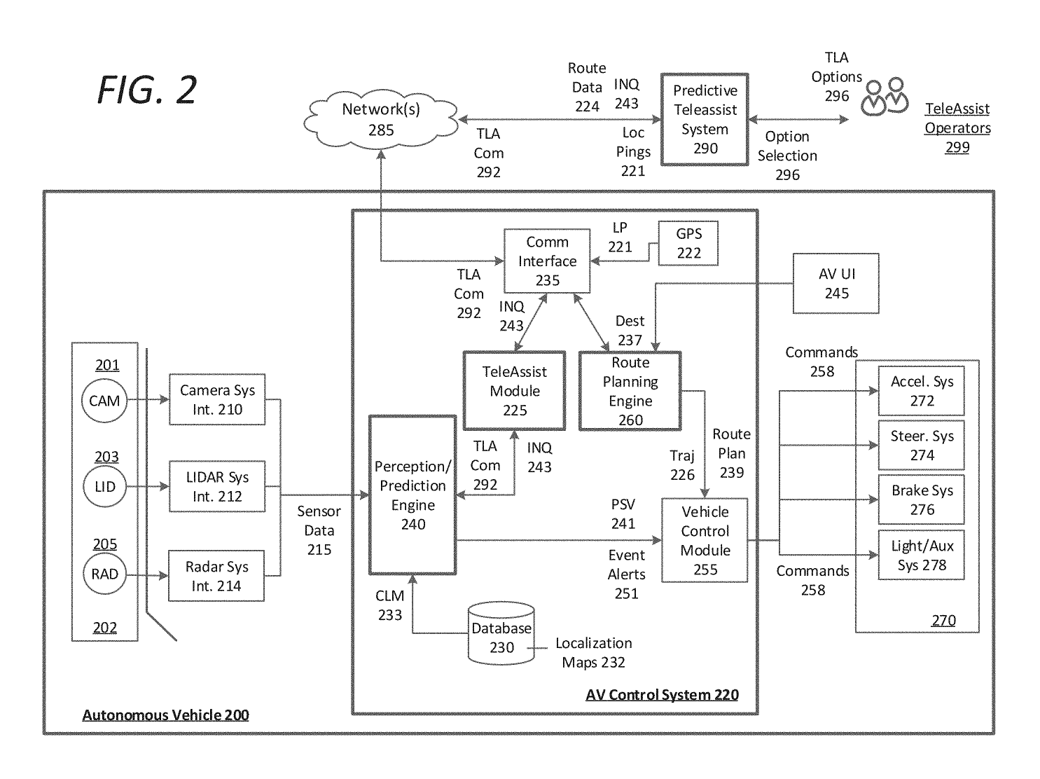

FIG. 2 is a block diagram illustrating an example autonomous vehicle (AV) operated by a control system implementing a teleassistance module, as described herein. In an example of FIG. 2, a control system 220 can autonomously operate the AV 200 in a given geographic region for a variety of purposes, including transport services (e.g., transport of humans, delivery services, etc.). In examples described, the AV 200 can operate without human control. For example, the AV 200 can autonomously steer, accelerate, shift, brake, and operate lighting components. Some variations also recognize that the AV 200 can switch between an autonomous mode, in which the AV control system 220 autonomously operates the AV 200, and a manual mode in which a driver takes over manual control of the acceleration system 272, steering system 274, braking system 276, and lighting and auxiliary systems 278 (e.g., directional signals and headlights).

According to some examples, the control system 220 can utilize specific sensor resources in order to autonomously operate the AV 200 in a variety of driving environments and conditions. For example, the control system 220 can operate the AV 200 by autonomously operating the steering, acceleration, and braking systems 272, 274, 276 of the AV 200 to a specified destination 237. The control system 220 can perform vehicle control actions (e.g., braking, steering, accelerating) and route planning using sensor information, as well as other inputs (e.g., transmissions from remote or local human operators, network communication from other vehicles, etc.).

In an example of FIG. 2, the control system 220 includes computational resources (e.g., processing cores and/or field programmable gate arrays (FPGAs)) which operate to process sensor data 215 received from a sensor system 202 of the AV 200 that provides a sensor view of a road segment upon which the AV 200 operates. The sensor data 215 can be used to determine actions which are to be performed by the AV 200 in order for the AV 200 to continue on a route to the destination 237. In some variations, the control system 220 can include other functionality, such as wireless communication capabilities using a communication interface 235, to send and/or receive wireless communications over one or more networks 285 with one or more remote sources. In controlling the AV 200, the control system 220 can generate commands 258 to control the various control mechanisms 270 of the AV 200, including the vehicle's acceleration system 272, steering system 257, braking system 276, and auxiliary systems 278 (e.g., lights and directional signals).

The AV 200 can be equipped with multiple types of sensors 202 which can combine to provide a computerized perception of the space and the physical environment surrounding the AV 200. Likewise, the control system 220 can operate within the AV 200 to receive sensor data 215 from the collection of sensors 202 and to control the various control mechanisms 270 in order to autonomously operate the AV 200. For example, the control system 220 can analyze the sensor data 215 to generate low level commands 258 executable by the acceleration system 272, steering system 257, and braking system 276 of the AV 200. Execution of the commands 258 by the control mechanisms 270 can result in throttle inputs, braking inputs, and steering inputs that collectively cause the AV 200 to operate along sequential road segments to a particular destination 237.

In more detail, the sensors 202 operate to collectively obtain a sensor view for the AV 200 (e.g., in a forward operational direction, or providing a 360 degree sensor view), and further to obtain situational information proximate to the AV 200, including any potential hazards or obstacles. By way of example, the sensors 202 can include multiple sets of camera systems 201 (video cameras, stereoscopic cameras or depth perception cameras, long range monocular cameras), LIDAR systems 203, one or more radar systems 205, and various other sensor resources such as sonar, proximity sensors, infrared sensors, and the like. According to examples provided herein, the sensors 202 can be arranged or grouped in a sensor system or array (e.g., in a sensor pod mounted to the roof of the AV 200) comprising any number of LIDAR, radar, monocular camera, stereoscopic camera, sonar, infrared, or other active or passive sensor systems.

Each of the sensors 202 can communicate with the control system 220 utilizing a corresponding sensor interface 210, 212, 214. Each of the sensor interfaces 210, 212, 214 can include, for example, hardware and/or other logical components which are coupled or otherwise provided with the respective sensor. For example, the sensors 202 can include a video camera and/or stereoscopic camera system 201 which continually generates image data of the physical environment of the AV 200. The camera system 201 can provide the image data for the control system 220 via a camera system interface 210. Likewise, the LIDAR system 203 can provide LIDAR data to the control system 220 via a LIDAR system interface 212. Furthermore, as provided herein, radar data from the radar system 205 of the AV 200 can be provided to the control system 220 via a radar system interface 214. In some examples, the sensor interfaces 210, 212, 214 can include dedicated processing resources, such as provided with field programmable gate arrays (FPGAs) which can, for example, receive and/or preprocess raw image data from the camera sensor.

In general, the sensor systems 202 collectively provide sensor data 215 to a perception/prediction engine 240 of the control system 220. The perception/prediction engine 240 can access a database 230 comprising stored localization maps 232 of the given region in which the AV 200 operates. The localization maps 232 can comprise highly detailed ground truth data of each road segment of the given region. For example, the localization maps 232 can comprise prerecorded data (e.g., sensor data including image data, LIDAR data, and the like) by specialized mapping vehicles or other AVs with recording sensors and equipment, and can be processed to pinpoint various objects of interest (e.g., traffic signals, road signs, and other static objects). As the AV 200 travels along a given route, the perception/prediction engine 240 can access a current localization map 233 of a current road segment to compare the details of the current localization map 233 with the sensor data 215 in order to detect and classify any objects of interest, such as moving vehicles, pedestrians, bicyclists, and the like.

In various examples, the perception/prediction engine 240 can dynamically compare the live sensor data 215 from the AV's sensor systems 202 to the current localization map 233 as the AV 200 travels through a corresponding road segment. The perception/prediction engine 240 can flag or otherwise identify any objects of interest in the live sensor data 215 that can indicate a potential hazard. In accordance with many examples, the perception/prediction engine 240 can output a processed sensor view 241 indicating such objects of interest to a vehicle control module 255 of the AV 200. In further examples, the perception/prediction engine 240 can predict a path of each object of interest and determine whether the AV control system 220 should respond or react accordingly. For example, the perception/prediction engine 240 can dynamically calculate a collision probability for each object of interest, and generate event alerts 251 if the collision probability exceeds a certain threshold. As described herein, such event alerts 251 can be processed by the vehicle control module 255 that generates control commands 258 executable by the various control mechanisms 270 of the AV 200, such as the AV's acceleration, steering, and braking systems 272, 274, 276.

On a higher level, the AV control system 220 can include a route planning engine 260 that provides the vehicle control module 255 with a route plan 239 and a travel trajectory 226 along a current route 239 to a destination 237. The current route 239 may be determined by a backend on-demand transport system, or may be determined by the AV 200 via access to a local or external mapping service. In some aspects, the AV 200 can include a user interface 245, such as a touch-screen panel or speech recognition features, which can enable a passenger to input a destination 237. Additionally or alternatively, the AV control system 220 can include a communication interface 235 providing the AV 200 with connectivity to one or more networks 285.

In mapping the current route 239, the route planning engine 260 can generally utilize an on-board mapping engine or an external mapping service by transmitting map calls over the network(s) 285 in order to determine a most optimal route plan 239 from a current location of the AV 200 to the destination 237. This route plan 239 may be determined based on distance, time, traffic conditions, additional pick-ups (e.g., for carpooling services), and the like. For each successive road segment on which the AV 200 travels, the route planning engine 260 can provide trajectory data 226 to the vehicle control module 255 to enable the vehicle control module 255 to operate the AV 200 safely to the next road segment or the destination 237. For example, the trajectory data 226 can indicate that the vehicle control module 255 must change lanes or make a turn in order to proceed to the next road segment along the current route plan 239.

According to examples provided herein, the vehicle control module 255 can utilize the trajectory data 226, the processed sensor view 241, and event alerts 251 to autonomously operate the control mechanisms 270 of the AV 200. As a basic example, to make a simple turn based on the trajectory data 226, the vehicle control module 255 can generate control commands 258 that cause the lights and auxiliary systems 278 of the AV 200 to activate the appropriate directional signal, the braking system 276 to slow the AV 200 down for the turn, the steering system 274 to steer the AV 200 into the turn, and the acceleration system 272 to propel the AV 200 when exiting the turn. In further examples, event alerts 251 may indicate potential hazards such as a pedestrian crossing the road, a nearby bicyclist, obstacles on the road, a construction area, proximate vehicles, an upcoming traffic signal and signal state, and the like. The vehicle control module 255 can respond to each event alert 251 on a lower level while, on a higher level, operating the AV 200 along the determined route plan 239 using the processed sensor view 241.

According to examples described herein, the control system 220 can further include a teleassistance module 225 in communication with a predictive teleassistance system 290, such as the predictive teleassistance system 100 described with respect to FIG. 1. In some aspects, the AV 200 can initiate a teleassistance inquiry 243 to the predictive teleassistance system 290. For example, the perception/prediction engine 240 can generate a teleassist inquiry 240 when it detects a teleassistance situation, such as an indeterminate object (e.g., a plastic bag) or experiences a detection anomaly (e.g., an occlusion in the sensor data 215).

In various implementations, when an teleassistance location or scenario is detected, the perception/prediction engine 240 can submit the teleassistance inquiry 243 to the teleassistance module 225. The teleassistance module 225 can treat the inquiry 243 based on the type of anomaly to, for example, compile sensor data 215, prioritize certain types of sensor data 215, encode the sensor data 215 at different rates or qualities, specify an anomalous object in the sensor data 215 (e.g., using a bounding box), and/or incorporating telemetry, diagnostic data, and/or localization data (e.g., position and orientation of the AV 200) with the inquiry 243. The teleassistance module 225 may then transmit the inquiry 243 to the predictive teleassistance system 290.

As described herein the predictive teleassistance system 290 can generate a set of teleassist decision options 296 for analysis by a teleassistance operator 299. The teleassistance operator 299 can make an option selection 296, and the predictive teleassistance system 290 can generate a teleassistance command 292 based on the option selection 296. In various examples, the teleassistance operators 299 may be human operators trained to analyze and resolve anomalies.

According to examples, the AV 200 can include a location-based resource, such as a GPS module 222, and can transmit location pings 221 to the predictive teleassistance system 290 over the one or more networks 285. Additionally, the route planning engine 260 can transmit route data 224 to the predictive teleassistance system 290, indicating the current route plan 239. The predictive teleassistance system 290 can utilize the route data 224 and the location pings 221 to monitor and track the AV 200 as the AV 200 travels throughout the given region.

In various aspects, the predictive teleassistance system 290 can initiate communications with the AV 200 when a predicted teleassistance location is identified. Accordingly, when the predictive teleassistance system 290 determines a predicted teleassistance location without responding to a teleassistance inquiry 243, the predictive teleassistance system 290 can generate a set of teleassistance decision options 296 selectable by a teleassistance operator 299. As described, the teleassistance operator 299 can make an option selection 296 from the set of teleassistance options 296. Thereafter, the predictive teleassist system 290 can generate a teleassistance command 292 for transmission back to the AV 200.

The AV 200 can receive the teleassistance command 292, which can be processed by either the teleassistance module 225 or the route planning engine 260. In some aspects, the teleassistance command 292 can include information resolving an anticipated upcoming object or occlusion. In such aspects, the teleassistance module 225 can provide the teleassistance command 292 to the perception/prediction engine 240 in order to enable the perception/prediction engine 240 to anticipate the object or occlusion. In variations, the teleassistance command 292 can comprise a route update instruction to cause the route planning engine 260 to update the route plan 239 in order to plan for, preempt, or avoid the predicted teleassistance location. The updated route plan 239 can be processed by the vehicle control module 255, which can modulate acceleration, braking, and steering inputs accordingly to follow the updated route plan 239.

Autonomous Vehicle in Operation

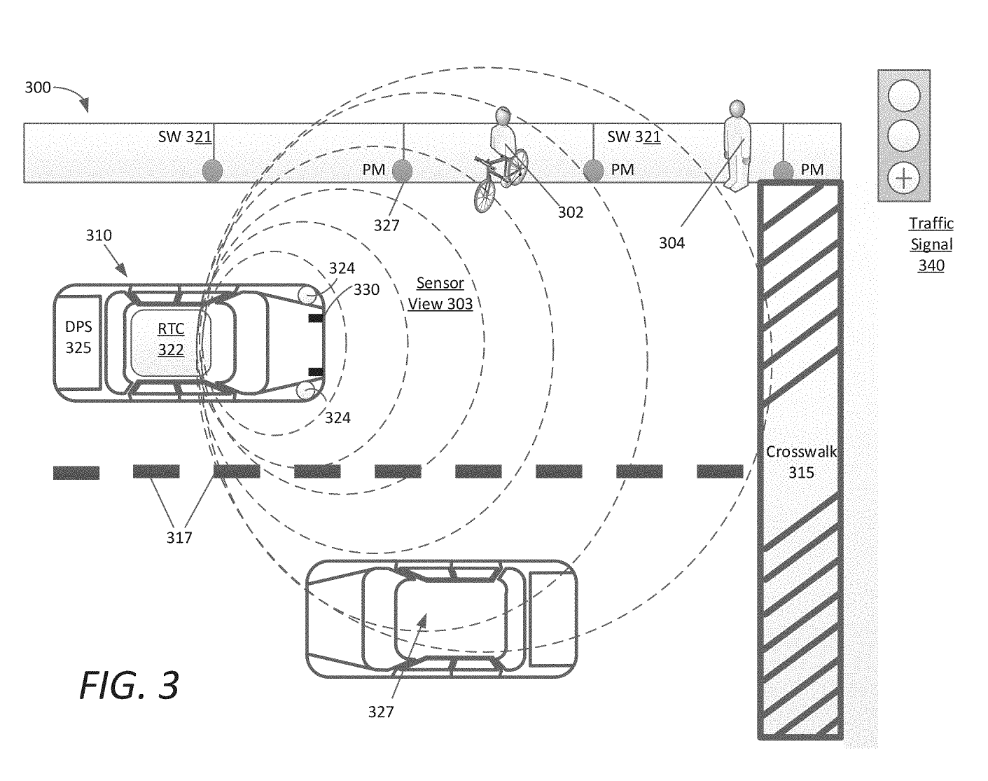

FIG. 3 shows an example of an autonomously controlled autonomous vehicle utilizing sensor data to navigate an environment in accordance with example implementations. In an example of FIG. 3, the autonomous vehicle 310 may include various sensors, such as a roof-top camera array (RTC) 322, forward-facing cameras 324 and laser rangefinders 330. In some aspects, a data processing system 325, comprising a computer stack that includes a combination of one or more processors, FPGAs, and/or memory units, can be positioned in the cargo space of the vehicle 310.

According to an example, the vehicle 310 uses one or more sensor views 303 (e.g., a stereoscopic or 3D image of the environment 300) to scan a road segment on which the vehicle 310 traverses. The vehicle 310 can process image data or sensor data, corresponding to the sensor views 303 from one or more sensors in order to detect objects that are, or may potentially be, in the path of the vehicle 310. In an example shown, the detected objects include a bicyclist 302, a pedestrian 304, and another vehicle 327—each of which may potentially cross into a road segment along which the vehicle 310 traverses. The vehicle 310 can use information about the road segment and/or image data from the sensor views 303 to determine that the road segment includes a divider 317 and an opposite lane, as well as a sidewalk (SW) 321, and sidewalk structures such as parking meters (PM) 327.

The vehicle 310 may determine the location, size, and/or distance of objects in the environment 300 based on the sensor view 303. For example, the sensor views 303 may be 3D sensor images that combine sensor data from the roof-top camera array 322, front-facing cameras 324, and/or laser rangefinders 330. Accordingly, the vehicle 310 may accurately detect the presence of objects in the environment 300, allowing the vehicle 310 to safely navigate the route while avoiding collisions with other objects.

According to examples, the vehicle 310 may determine a probability that one or more objects in the environment 300 will interfere or collide with the vehicle 310 along the vehicle's current path or route. In some aspects, the vehicle 310 may selectively perform an avoidance action based on the probability of collision. The avoidance actions may include velocity adjustments, lane aversion, roadway aversion (e.g., change lanes or drive further from the curb), light or horn actions, and other actions. In some aspects, the avoidance action may run counter to certain driving conventions and/or rules (e.g., allowing the vehicle 310 to drive across center line to create space for bicyclist).

The AV 310 can further detect certain road features that can increase the vehicle's alertness, such as a crosswalk 315 and a traffic signal 340. In the example shown in FIG. 3, the AV 310 can identify certain factors that can cause the vehicle 310 to enter a high alert state, such as the pedestrian 304 being proximate to the crosswalk 315 or the bicyclist 302 being on the road. Furthermore, the AV 310 can identify the signal state of the traffic signal 340 (e.g., green) to determine acceleration and/or braking inputs as the AV 310 approaches the intersection. At any given time, the AV 310 can detect an anomaly—such as an indeterminate object or an issue with a sensor—and query a backend teleassistance system to resolve the anomaly.

According to examples described herein, the AV 310 may request remote teleassistance from a teleassistance system and human operators when an issue arises. Such issues can comprise confusion by the data processing system 325 regarding an object (e.g., the bicyclist 302) or occlusion, a traffic situation, a traffic incident, an overwhelmed data processing system 325, and the like. Additionally, the AV 310 can be provided with preemptive remote teleassistance from the predictive teleassistance system, as described herein.

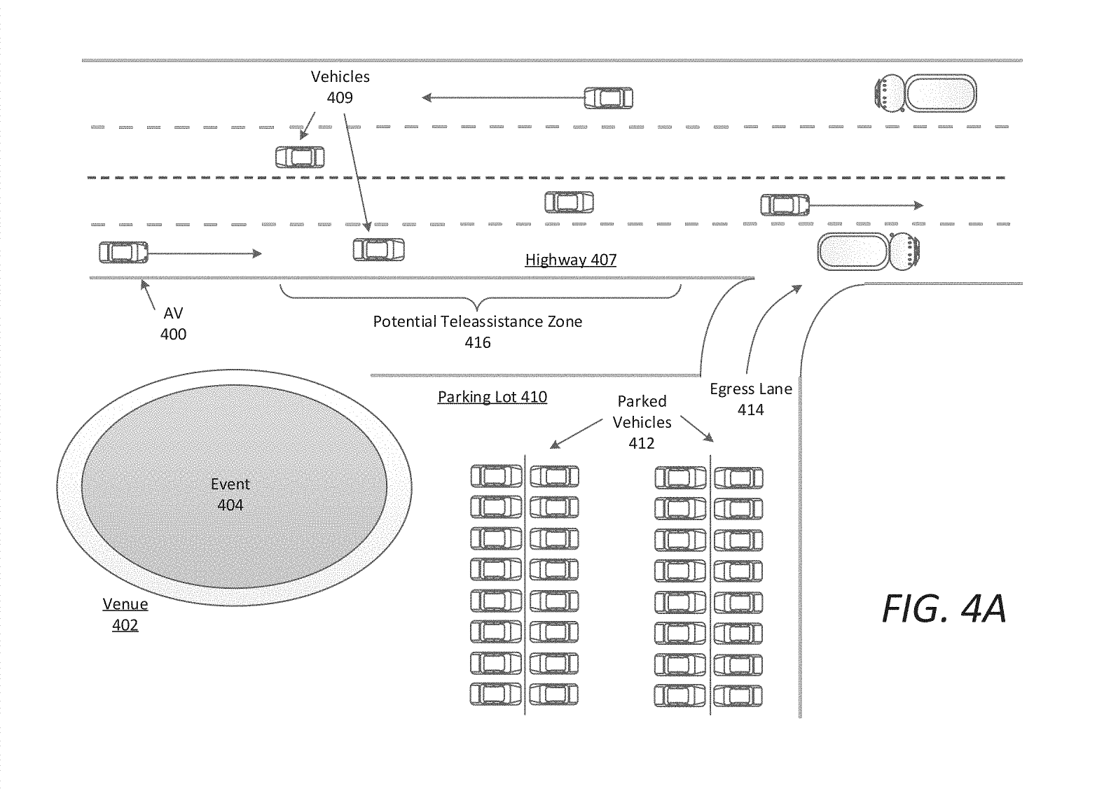

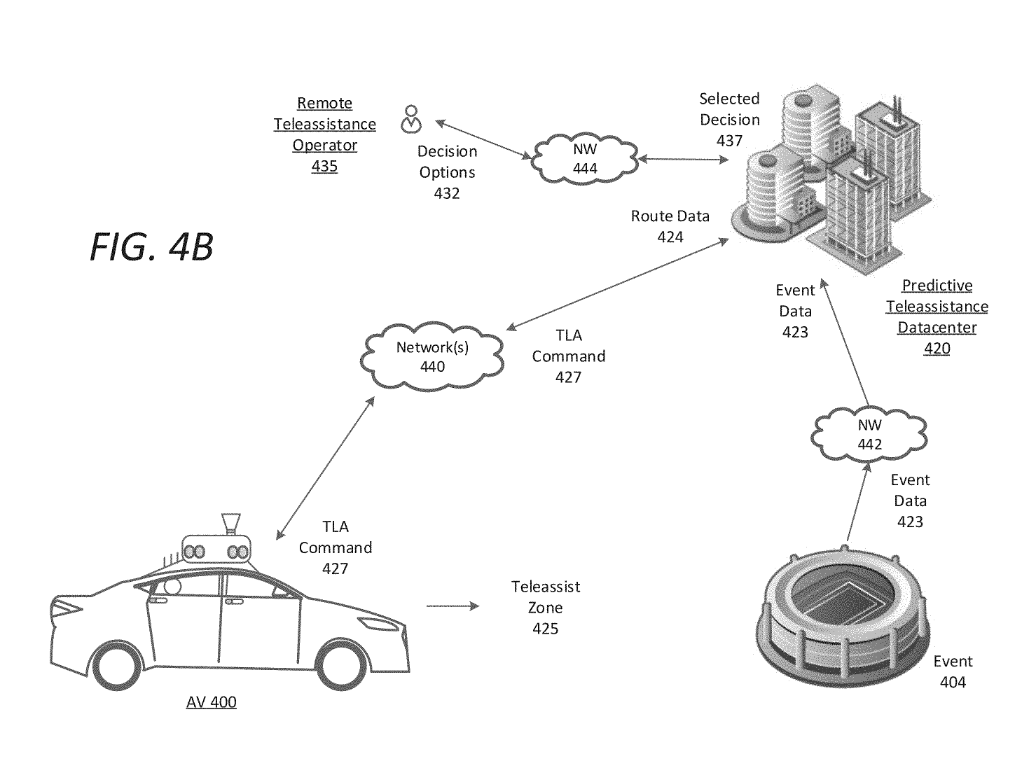

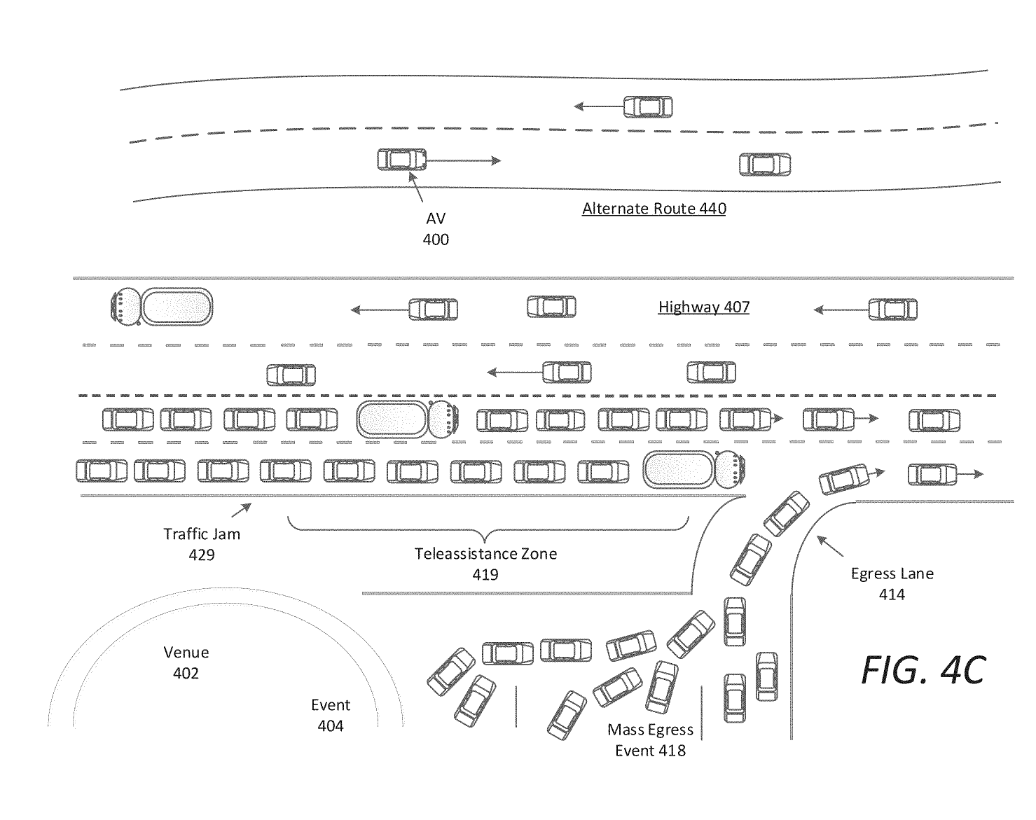

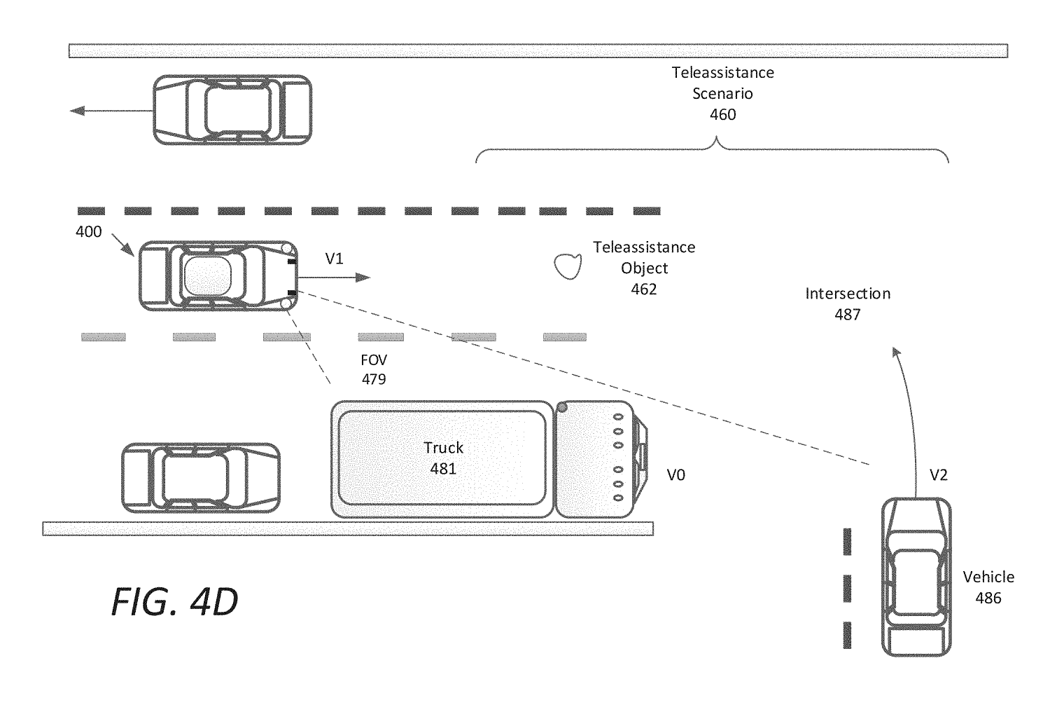

FIGS. 4A through 4D illustrate example implementations of an autonomous vehicle utilizing predictive teleassistance, in accordance with example implementations. Referring to FIG. 4A, an AV 405 can operate throughout a given region, such as on a highway 407. When traffic is flowing, the AV 405 can operate normally in detecting proximate vehicles 409 and characteristics of the highway 407 (e.g., the speed limit and lane dividers) and operating the control mechanisms accordingly. Meanwhile, a backend predictive teleassistance system 100—such as that shown and described with respect to FIG. 1—can monitor potential teleassistance locations 416 ahead of the AV 405 along the AV's 405 current route (e.g., utilizing historical data and a live traffic map). In conjunction, the predictive teleassistance system 100 can monitor additional information corresponding to an event 404 hosted at a venue 402. The venue 402 can be associated with a parking lot 410 in which a large number of parked vehicles 412 are parked.

Using historical data, the predictive teleassistance system 100 may determine that the stretch of highway 407 on which the AV 405 currently travels comprises a potential teleassistance location or teleassistance zone 416. For example, utilizing historical data and event data, the predictive teleassistance system 100 can determine that during mass egress events from the venue 402, vehicles merging onto the highway 407 via an egress lane 414 can create significant traffic jams, which can directly and/or indirectly impact other potential teleassistance locations.

According to examples described herein, the predictive teleassistance system 100 can monitor a live traffic map of an area in which the AV 405 operates, and also live event data corresponding to the event 404 at the venue 402. For example, if the event 404 comprises a technology conference, the predictive teleassistance system 100 can monitor a schedule of the conference and any live updates by accessing a third party resource (e.g., a social media site) associated with the technology conference. The predictive teleassistance system 100 can also utilize historical data indicating the traffic impact and past teleassistance requests due to mass egress events corresponding to the venue 402 in general, and/or specific to the recurring technology conference.

Accordingly, given the historical data and/or event data, the predictive teleassistance system 100 can dynamically calculate a probability that the potential teleassistance location or zone 416 will result in a teleassistance request from an AV sometime in the near future (e.g., within the next few minutes). If the probability exceeds a certain threshold (e.g., 90%), then the predictive teleassistance system 100 can initiate the process of identifying upstream decision options—relative to the teleassistance zone 416—for AVs converging towards the teleassistance zone 416. As described herein, the predictive teleassistance system 100 may then leverage human operators to make the final decisions to be executed by AVs on the ground. In the example shown in FIG. 4A, the AV 400 continues to operate normally without receiving a teleassistance command from the predictive teleassistance system 100 due to the ongoing event 404. For example, the predictive teleassistance system 100 calculates a low probability of teleassistance requests from the potential teleassistance zone 416.

Referring to FIG. 4B, the predictive teleassistance system 100 can be housed in a remote datacenter 420 that monitors the given region in which the AV 400 operates. The datacenter 420 can receive event data 423 from the event 404 over a network 442. In some aspects, the event data 423 can indicate a general schedule of the event 404. Additionally or alternatively, the event data 423 can indicate live, real-time, progress updates for the event 404, including information indicating the event's conclusion.

Utilizing historical data, the event data 423, and/or live mapping data, the predictive teleassistance datacenter 420 can calculate a probability that an upcoming teleassistance zone 425 for the AV 400 will result in future teleassistance requests. In doing so, the predictive teleassistance datacenter 420 can preempt such requests for occurring in the first place. If the probability exceeds a certain threshold, the datacenter 420 can identify any AVs 400 having routes converging on the teleassistance zone 425 based on route data 424 received from the AVs 400 over one or more networks 440. Based on the trajectory and route of each AV 400 indicated in the route data 424, the datacenter 420 can determine a set of decision options 432 available for the AV 400 to address, bypass, or otherwise resolve the teleassistance zone 425. In various examples, the set of decision options 432 can be presented on a user interface feature for a human teleassistance operator 435 to make a selection. The set 432 can include two or more decision options, which can vary from individual lane selections, alternative routes, etc.

The datacenter 420 can transmit the set of decisions options 432 to the computing device of the teleassistance operator 435 over a network 444 to enable the operator 435 to make a selection. In various examples, the operator 435 can quickly review each of the decision options 432 and select what the operator 435 believes to be the best decision 437. Data indicating the selected decision 437 can be transmitted back to the datacenter 420 over the network 444. The datacenter 420 may then generate a teleassistance command 427 corresponding to the selected decision 437, and transmit the command 427 to the AV 400 over the network(s) 440. The teleassistance command 427 can be executable by the AV 400 to address, bypass, or otherwise resolve the teleassistance zone 425, as described.

Referring to FIG. 4C, an example scenario is shown in which the conclusion of the event 404 at the venue 402 has resulted in a traffic jam 429 on the highway 407. According to examples described herein, the predictive teleassistance system 100 may have calculated a probability that the mass egress event 418 corresponding to the conclusion of the event 404 at the venue 402 would most likely result in one or more teleassistance requests from AVs converging towards the entrance of the egress lane 414 onto the highway 407. In certain implementations, the predicted teleassistance location or zone 419 can be direction specific or even lane specific. In the scenario shown in FIG. 4C, the predictive teleassistance system 100 can predict—prior to the mass egress event 418—that the traffic jam 429 caused by the mass egress event 418 would be unidirectional, and so only AVs operating in the affected direction may be provided with teleassistance commands to preemptively resolve the teleassistance zone 419. Accordingly, the AV 400 provided with the teleassistance command 427 shown in FIG. 4B may have been preemptively rerouted on an alternative route 440 well prior to the occurrence of the traffic jam 429.

FIG. 4D illustrates a teleassistance scenario 460 calculated by the predictive teleassistance system 100 as having a probability beyond a threshold to cause teleassistance requests by encountering AVs 400. In the example shown in FIG. 4D, a parked truck 481 may cause an occlusion in the field of view 479 of the AV 400, and can potential block the view of a vehicle 486 entering the intersection 487. According to examples described herein, the predictive teleassistance system 100 can analyze live traffic data, map data, sensor data from other AVs, and/or historical data to determine the teleassistance scenario 460. For example, the location at which the truck 481 is parked may be a common location for truck parking, such as an unloading zone for a business. Furthermore, the historical data may indicate a routine for truck parking as shown in FIG. 4D, and enable the predictive teleassistance system 100 to preemptively address the teleassistance scenario 460 prior to incoming AVs 400 entering the teleassistance scenario 460.

In still further examples, the predictive teleassistance system 100 may receive an alert or message from a local business associated with the truck 481, indicating the current unloading process. Such event data can factor into the probability calculation, or may act as a trigger for preemptive resolution of the teleassistance scenario 460. To address the occlusion in the AV's 400 field of view 479, the predictive teleassistance system 100 may transmit a teleassistance command causing the AV 400 to be rerouted prior to arriving at the teleassistance scenario 460. In variations, the teleassistance command may cause the AV 400 to preemptively slow down prior to detecting the occlusion, and can further instruct the AV 400 to enter the intersection with caution.

Also shown in FIG. 4D is a teleassistance object, which can comprise an object that AVs 400 have trouble classifying, causing them to historically stop to transmit teleassistance requests. In the example shown in FIG. 4D, the teleassistance object 462 can comprise a persistent pothole which the predictive teleassistance system 100 can instruct the AV 400 to ignore or avoid with a cautious swerving maneuver, depending on the human operator selection. Accordingly, the predictive teleassistance system 100 can preemptively address the teleassistance object 462 prior to the object 462 being detected by the AV 400. Thus, when the AV 400 approaches and detects the teleassistance object 462, the AV 400 will already have a teleassistance command correlated to the object 462, and an instruction regarding how to treat the object 462 (e.g., ignore, avoid, etc.).

Methodology

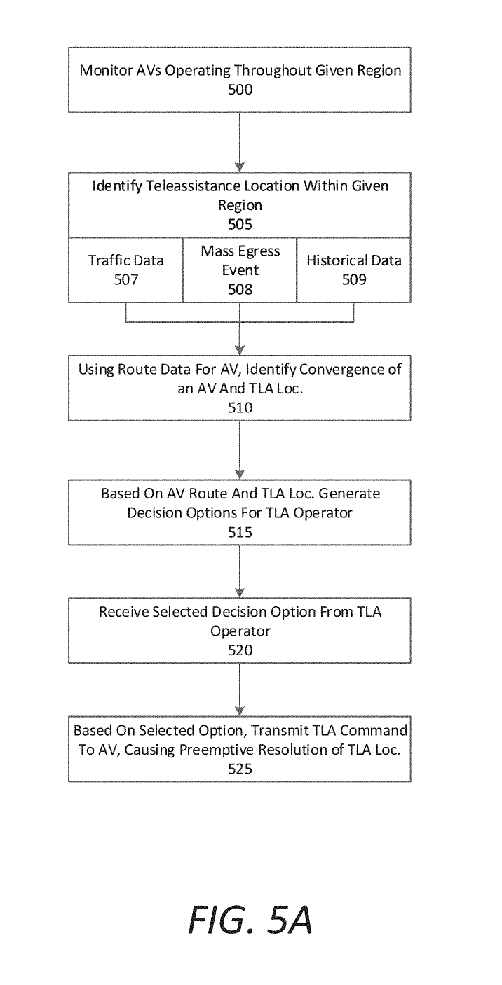

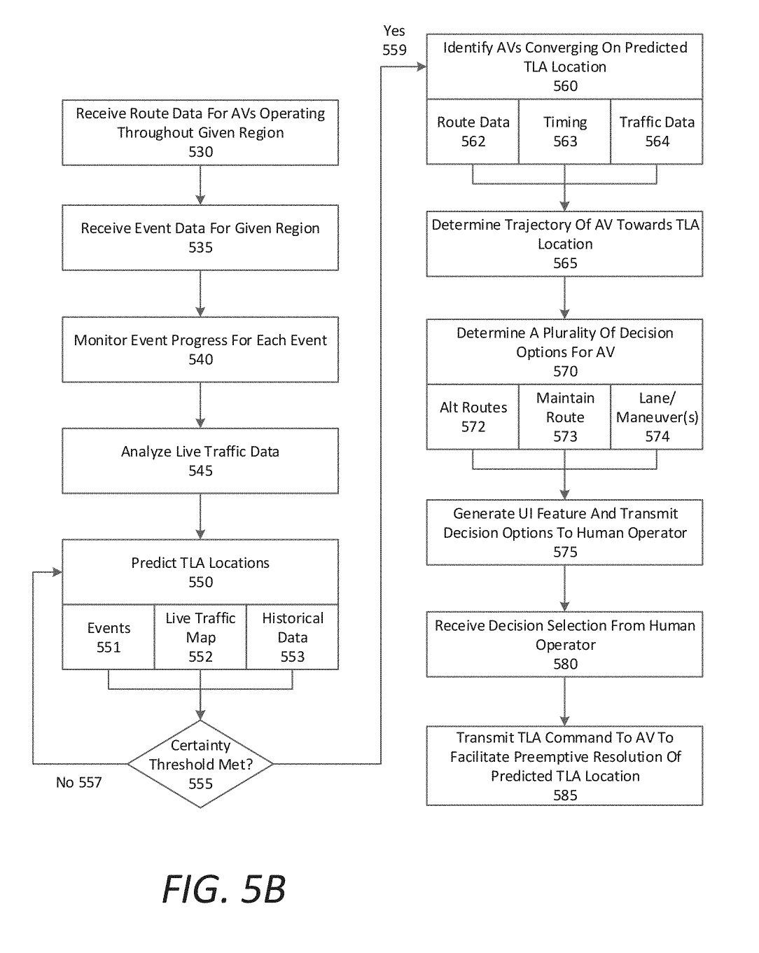

FIGS. 5A and 5B are flow charts describing example methods of predicting and preemptively resolving teleassistance locations for AVs, according to examples described herein. In the below discussion of FIGS. 5A and 5B, reference may be made to reference characters representing like features discusses with respect to FIG. 1. Furthermore, the below processes described in connection with FIGS. 5A and 5B may be performed by an example predictive teleassistance system 100 of FIG. 1. Referring to FIG. 5A, the predictive teleassistance system 100 can monitor AVs 180 operating through a given region (500). The predictive teleassistance system 100 can identify a teleassistance location 139 within the given region (505). The teleassistance location 139 can be identified through analysis of historical data 142 (509), live traffic data (507), and/or event data indicating a mass egress event (508).

The predictive teleassistance system 100 may then identify a convergence of an AV 180 and the teleassistance location 139 using route data 188 for the AV 180 (510). Based on the AV route data 188 and the teleassistance location 139, the predictive teleassistance system 100 can generate a set of decision options 123 for a human teleassistance operator 174 (515). The predictive teleassistance system 100 may then receive data indicating a selected decision option 132 from the teleassistance operator 174 (520). Based on the selection option 132, the predictive teleassistance system 100 can generate and transmit a teleassistance command 177 to the AV 180, causing the AV 180 to preemptively resolve the teleassistance location 139 (525).

FIG. 5B is a flow chart detailing a lower level method of providing predictive teleassistance to AVs. According to various examples, the predictive teleassistance system 100 can receive route data 188 for AVs 180 operating throughout a given region (530). The predictive teleassistance system 100 may also receive event data 144 (or third party data 193) for the given region, as described herein (535). In some examples, the predictive teleassistance system 100 can further monitor event progress for each of the events (540). In conjunction, the predictive teleassistance system 100 can analyze live traffic data 137 (e.g., based on location pings 113) from the AVs 180 (545).

In many implementations, the predictive teleassistance system 100 can predict teleassistance locations 139 within the given region (550). For example, the predictive teleassistance system 100 can predict the teleassistance locations 139 based on event data 144 (551), a live traffic map 137 (552), and/or historical teleassistance data 142 (553). In predicting the teleassistance locations 139, the predictive teleassistance system 100 can dynamically calculate a probability that future teleassistance request will be received from the location 139, and determine whether the probability meets a certain threshold (555). If not (557), then the predictive teleassistance system 100 can continue to receive calculate the probability for that potential location until the probability threshold is met. However, if the probability threshold is met (559), then the predictive teleassistance system 100 can identify AVs 180 that are converging on the teleassistance location 139 (560). In doing so, the predictive teleassistance system 100 can utilize the AV route data 188 (562), the location pings 113 (563), and live traffic data 137 (564).

In some aspects, the predictive teleassistance system 100 can utilize the foregoing data to determine a trajectory of an AV towards the predicted teleassistance location 139 (565). The predictive teleassistance system 100 can then determine a plurality of decision options 123 for the AV 180 (570). As described herein, the decision options 123 can comprise one or more alternate routes (572), an action (e.g., slowing down or switching to a high caution mode) (573), or can indicate a lane change or maneuver (574). The predictive teleassistance system 100 may then generate a user interface feature and transmit the decision options 123 to a human teleassistance operator 174 (575). After the human operator 174 makes a selection, the predictive teleassistance system 100 can receive a data indicating the decision selection 132 by the operator 174 (580). Based on the decision selection 132, the predictive teleassistance system 100 can transmit a teleassistance command 177 to the AV 180 to facilitate the AV's 180 preemptive resolution of the predicted teleassistance location 139 (585).

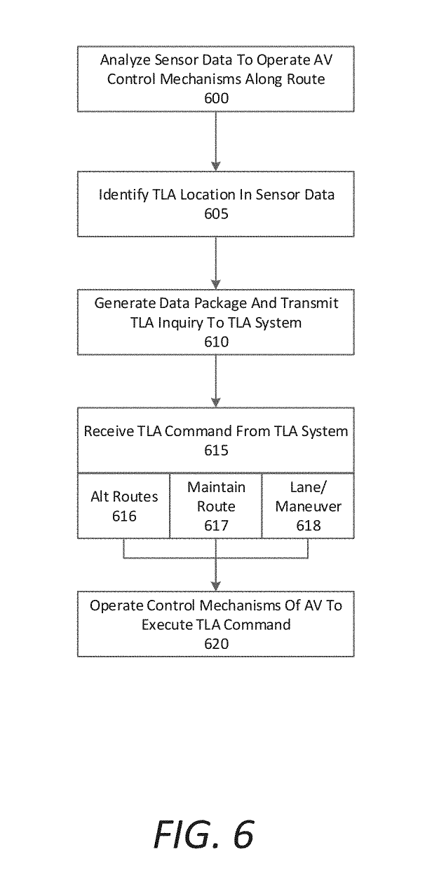

FIG. 6 is a flow chart describing an example method of receiving predictive teleassistance by an autonomous vehicle, according to examples described herein. The below method described with respect to FIG. 6 may be performed by an example AV 200 in network communication with a backend predictive teleassistance system 290, as shown and described with respect to FIG. 2. According to examples described herein, the AV 200 can analyze sensor data 215 to operate the AV control mechanisms 270 along a current route plan 239 (600). In some aspects, the AV 200 can identify a teleassistance location in the sensor data 215 (605), generate a data package comprising sensor data 215 (e.g., image data) indicating the teleassistance location, and transmit a teleassistance inquiry 243 to the predictive teleassistance system 100 (610).

In other aspects, the predicative teleassistance system 100 can independently identify the teleassistance location, as described herein. In either case, the AV 200 can receive a teleassistance command 292 from the predictive teleassistance system (615). As described, the teleassistance command 292 can comprise an instruction to take one or more alternate routes (616), perform an action (e.g., slowing down or switching to a high caution mode) (617), or can indicate a lane change or maneuver (618). The AV 200 may then execute the teleassistance command 292 by operating the control mechanisms 270 of the AV 200 accordingly (620).

The methods described in connection with FIGS. 5A, 5B, and 6 may be ubiquitous for each AV 200 operating throughout the given region. Accordingly, the dynamic interactions between the predictive teleassistance system 100 and the AVs can be widespread, and can cover on the order of hundreds, thousands, tens of thousands, or even hundreds of thousands of AVs operating in any given mapped region.

Hardware Diagrams

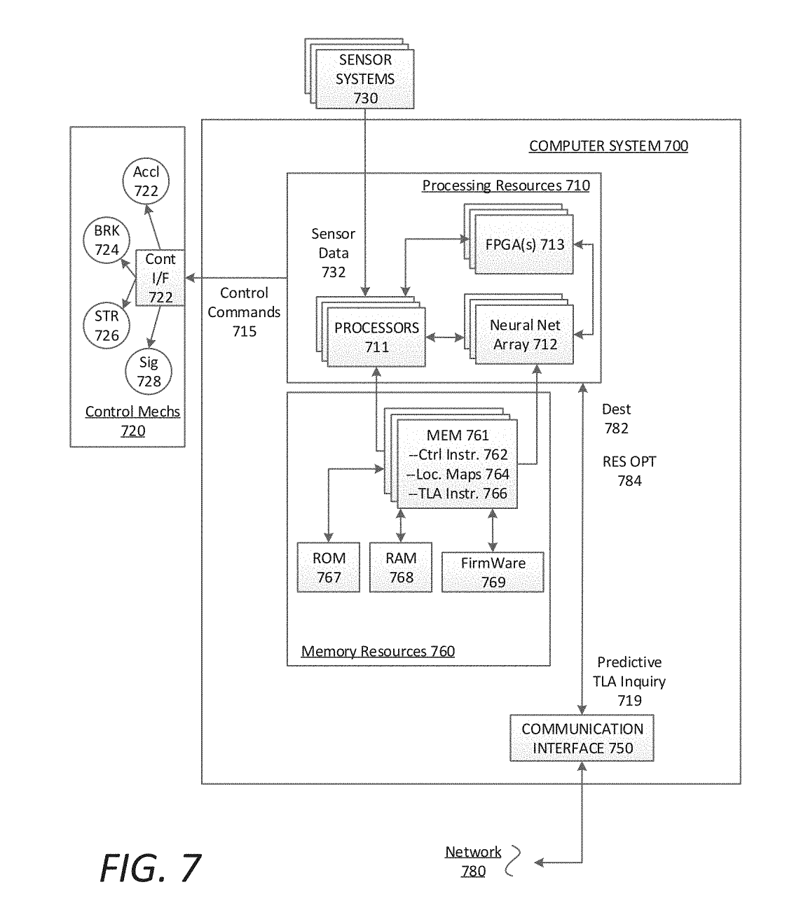

FIG. 7 is a block diagram illustrating a computer system upon which example AV processing systems described herein may be implemented. The computer system 700 can be implemented using a number of processing resources 710, which can comprise processors 711, field programmable gate arrays (FPGAs) 713. In some aspects, any number of processors 711 and/or FPGAs 713 of the computer system 700 can be utilized as components of a neural network array 712 implementing a machine learning model and utilizing road network maps stored in memory 761 of the computer system 700. In the context of FIG. 2, various aspects and components of the control system 220 can be implemented using one or more components of the computer system 700 shown in FIG. 7.

According to some examples, the computer system 700 may be implemented within an autonomous vehicle or autonomous vehicle (AV) with software and hardware resources such as described with examples of FIG. 2. In an example shown, the computer system 700 can be distributed spatially into various regions of the AV, with various aspects integrated with other components of the AV itself. For example, the processing resources 710 and/or memory resources 760 can be provided in a cargo space of the AV. The various processing resources 710 of the computer system 700 can also execute control instructions 762 using microprocessors 711, FPGAs 713, a neural network array 712, or any combination of the same.

In an example of FIG. 7, the computer system 700 can include a communication interface 750 that can enable communications over a network 780. In one implementation, the communication interface 750 can also provide a data bus or other local links to electro-mechanical interfaces of the vehicle, such as wireless or wired links to and from control mechanisms 720 (e.g., via a control interface 722), sensor systems 730, and can further provide a network link to a backend transport management system (implemented on one or more datacenters) over one or more networks 780. For example, the processing resources 710 can receive a destination 782 over the one or more networks 780, or via a local user interface of the AV.

The memory resources 760 can include, for example, main memory 761, a read-only memory (ROM) 767, storage device, and cache resources. The main memory 761 of memory resources 760 can include random access memory (RAM) 768 or other dynamic storage device, for storing information and instructions which are executable by the processing resources 710 of the computer system 700. The processing resources 710 can execute instructions for processing information stored with the main memory 761 of the memory resources 760. The main memory 761 can also store temporary variables or other intermediate information which can be used during execution of instructions by the processing resources 710. The memory resources 760 can also include ROM 767 or other static storage device for storing static information and instructions for the processing resources 710. The memory resources 760 can also include other forms of memory devices and components, such as a magnetic disk or optical disk, for purpose of storing information and instructions for use by the processing resources 710. The computer system 700 can further be implemented using any combination of volatile and/or non-volatile memory, such as flash memory, PROM, EPROM, EEPROM (e.g., storing firmware 769), DRAM, cache resources, hard disk drives, and/or solid state drives.

The memory 761 may also store localization maps 764 in which the processing resources 710—executing the control instructions 762—continuously compare to sensor data 732 from the various sensor systems 730 of the AV. Execution of the control instructions 762 can cause the processing resources 710 to generate control commands 715 in order to autonomously operate the AV's acceleration 722, braking 724, steering 726, and signaling systems 728 (collectively, the control mechanisms 720). Thus, in executing the control instructions 762, the processing resources 710 can receive sensor data 732 from the sensor systems 730, dynamically compare the sensor data 732 to a current localization map 764, and generate control commands 715 for operative control over the acceleration, steering, and braking of the AV. The processing resources 710 may then transmit the control commands 715 to one or more control interfaces 722 of the control mechanisms 720 to autonomously operate the AV through road traffic on roads and highways, as described throughout the present disclosure.

The memory 761 may also store teleassistance instructions 766 that the processing resources 710 can execute to identify detection or object anomalies, and transmit teleassistance inquiries to a backend teleassistance system over the network 780, and receive teleassistance commands 784 in response or preemptively for an upcoming teleassistance location identified by the predictive teleassistance system, as described throughout the present disclosure. Execution of the instructions 762, 764, 766 can cause the processing resources 710 to process the teleassistance command 784 accordingly to resolve the detected teleassistance location, object, or scenario. Thereafter, the processing resources 710 can generate control commands 715 to cause the control mechanisms 720 to autonomously operate the AV along the current route or an alternate route accordingly.

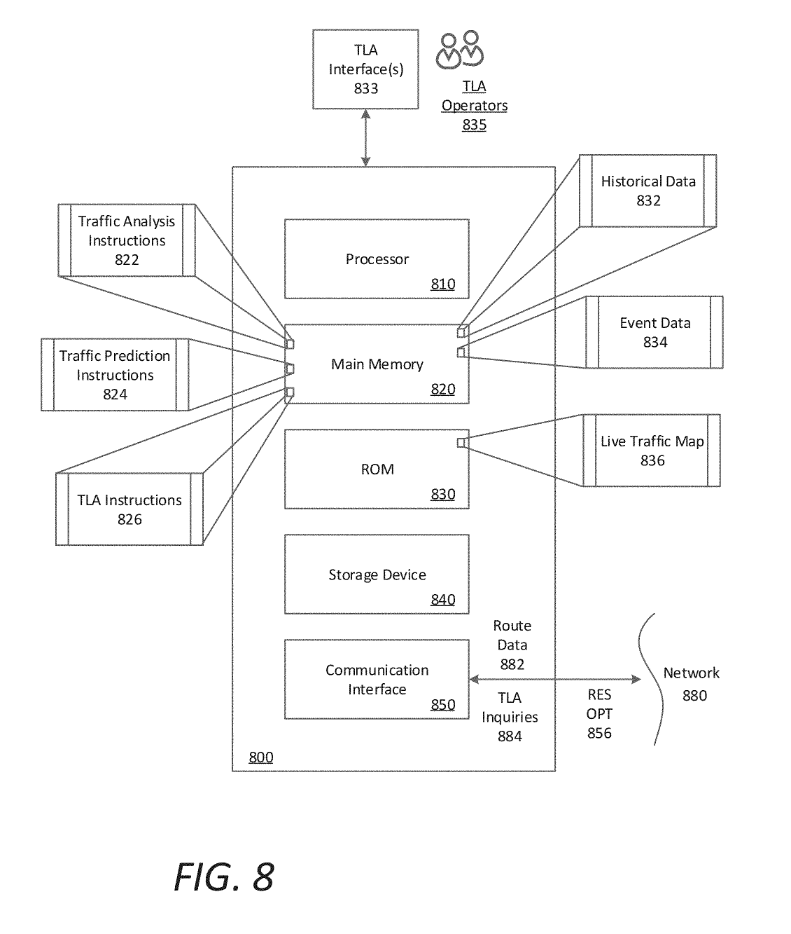

FIG. 8 is a block diagram that illustrates a computer system upon which examples described herein may be implemented. A computer system 800 can be implemented on, for example, a server or combination of servers. For example, the computer system 800 may be implemented as part of a network service for providing transportation services and/or for providing predictive teleassistance to AVs operating through a given region. In the context of FIG. 1, the predictive teleassistance system 100 may be implemented using a computer system 800 such as described by FIG. 8.

In one implementation, the computer system 800 includes processing resources 810, a main memory 820, a read-only memory (ROM) 830, a storage device 840, and a communication interface 850. The computer system 800 includes at least one processor 810 for processing information stored in the main memory 820, such as provided by a random access memory (RAM) or other dynamic storage device, for storing information and instructions which are executable by the processor 810. The main memory 820 also may be used for storing temporary variables or other intermediate information during execution of instructions to be executed by the processor 810. The computer system 800 may also include the ROM 830 or other static storage device for storing static information and instructions for the processor 810. A storage device 840, such as a magnetic disk or optical disk, is provided for storing information and instructions.

The communication interface 850 enables the computer system 800 to communicate over one or more networks 880 (e.g., cellular network) through use of the network link (wireless or wired). Using the network link, the computer system 800 can communicate with one or more computing devices, one or more servers, and/or one or more autonomous vehicles. In accordance with examples, the computer system 800 can receive route data 882 from AVs. The executable instructions stored in the memory 830 can include teleassistance location prediction instructions 822, which the processor 810 executes to parse through stored historical data 832, event data 834, and/or a live traffic map 836 to predict teleassistance locations.

The executable instructions stored in the memory 820 can also include teleassistance instructions 824, which enables the computer system 800 to generate respective sets of decision options for AVs converging upon a predicted teleassistance location. In some aspects, execution of the teleassistance instructions 824 can cause the computer system 800 to transmit the set of teleassistance decision options over one or more teleassistance interfaces 833 to human teleassistance operators 835, which can make a selection, causing the processor 810 to generate and then transmit a teleassistance command 856 back to the AVs.

By way of example, the instructions and data stored in the memory 820 can be executed by the processor 810 to implement an example predictive teleassistance system 100 of FIG. 1. In performing the operations, the processor 810 can receive route data 882, generate respective sets of decision options, receive a selection option from human teleassistance operators 835, and transmit teleassistance command 856 to AVs to facilitate in preempting predicted teleassistance locations.

The processor 810 is configured with software and/or other logic to perform one or more processes, steps and other functions described with implementations, such as described with respect to FIGS. 1-6, and elsewhere in the present application. Examples described herein are related to the use of the computer system 800 for implementing the techniques described herein. According to one example, those techniques are performed by the computer system 800 in response to the processor 810 executing one or more sequences of one or more instructions contained in the main memory 820. Such instructions may be read into the main memory 820 from another machine-readable medium, such as the storage device 840. Execution of the sequences of instructions contained in the main memory 820 causes the processor 810 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

What is claimed is:

1. A teleassistance system for autonomously vehicles (AVs) operating throughout a given region, the teleassistance system comprising:
one or more processors; and
one or more memory resources storing instructions that, when executed by the one or more processors, cause the one or more processors to:
monitor the AVs operating throughout the given region;
predict a teleassistance location within the given region;
using route data for a respective AV, determine a convergence of the respective AV with the predicted teleassistance location;
generate a plurality of decision options for a human teleassistance operator to resolve the predicted teleassistance location for the respective AV;
receive a selection of a decision option from the human teleassistance operator; and
transmit a teleassistance command corresponding to the selected decision option to the respective AV in order to cause the respective AV to preemptively resolve the predicted teleassistance location.

2. The teleassistance system of claim 1, wherein the executed instructions cause the one or more processors to predict the teleassistance location using historical data for the given region.

3. The teleassistance system of claim 1, wherein the executed instructions further cause the one or more processors to:
receive location data from the AVs; and
generate a live traffic map for the given region based on the received location data from the AVs.

4. The teleassistance system of claim 3, wherein the executed instructions cause the one or more processors to predict the teleassistance location using a live traffic map of the given region.

5. The teleassistance system of claim 1, wherein the generated plurality of decision options comprise at least one of an alternate route, a lane selection, or a wait command.

6. The teleassistance system of claim 1, wherein the executed instructions further cause the one or more processors to:
receive event data from one or more third party sources indicating a mass egress event within the given region;
wherein the predicted teleassistance location corresponds to the mass egress event.

7. The teleassistance system of claim 1, wherein the predicted teleassistance location comprises at least one of an indeterminate object or an occlusion, and wherein the teleassistance command preemptively enables the respective AV to address the at least one of the indeterminate object or the occlusion prior to detection via on-board sensor data.

8. A non-transitory computer readable medium storing instructions that, when executed by one or more processors, cause the one or more processors to:
monitor AVs operating throughout a given region;
predict a teleassistance location within the given region;
using route data for a respective AV, determine a convergence of the respective AV with the predicted teleassistance location;
generate a plurality of decision options for a human teleassistance operator to resolve the predicted teleassistance location for the respective AV;
receive a selection of a decision option from the human teleassistance operator; and
transmit a teleassistance command corresponding to the selected decision option to the respective AV in order to cause the respective AV to preemptively resolve the predicted teleassistance location.

9. The non-transitory computer readable medium of claim 8, wherein the executed instructions cause the one or more processors to predict the teleassistance location using historical data for the given region.

10. The non-transitory computer readable medium of claim 8, wherein the executed instructions further cause the one or more processors to:
receive location data from the AVs; and
generate a live traffic map for the given region based on the received location data from the AVs.

11. The non-transitory computer readable medium of claim 10, wherein the executed instructions cause the one or more processors to predict the teleassistance location using a live traffic map of the given region.

12. The non-transitory computer readable medium of claim 8, wherein the generated plurality of decision options comprise at least one of an alternate route, a lane selection, or a wait command.

13. The non-transitory computer readable medium of claim 8, wherein the executed instructions further cause the one or more processors to:
receive event data from one or more third party sources indicating a mass egress event within the given region;
wherein the predicted teleassistance location corresponds to the mass egress event.

14. The non-transitory computer readable medium of claim 8, wherein the predicted teleassistance location comprises at least one of an indeterminate object or an occlusion, and wherein the teleassistance command preemptively enables the respective AV to address the at least one of the indeterminate object or the occlusion prior to detection via on-board sensor data.

15. A computer-implemented method of facilitating preemptive teleassistance to autonomous vehicles (AVs) operating throughout a given region, the method being performed by one or more processors and comprising:
monitoring the AVs operating throughout the given region;
predicting a teleassistance location within the given region;
using route data for a respective AV, determining a convergence of the respective AV with the predicted teleassistance location;
generating a plurality of decision options for a human teleassistance operator to resolve the predicted teleassistance location for the respective AV;
receiving a selection of a decision option from the human teleassistance operator; and
transmitting a teleassistance command corresponding to the selected decision option to the respective AV in order to cause the respective AV to preemptively resolve the predicted teleassistance location.

16. The method of claim 15, wherein the one or more processors predict the teleassistance location using historical data for the given region.

17. The method of claim 15, further comprising:
receiving location data from the AVs; and
generating a live traffic map for the given region based on the received location data from the AVs.

18. The method of claim 17, wherein the one or more processors predict the teleassistance location using a live traffic map of the given region.

19. The method of claim 15, wherein the generated plurality of decision options comprise at least one of an alternate route, a lane selection, or a wait command.

20. The method of claim 8, further comprising:
receiving event data from one or more third party sources indicating a mass egress event within the given region;
wherein the predicted teleassistance location corresponds to the mass egress event.
